(19) United States
(12) Patent Application Publication
(10) Pub. No.: US 2011/0147150 A1
(43) Pub. Date: Jun. 23, 2011

(54) ATTACHMENT ARRANGEMENT FOR A REFRIGERANT COMPRESSOR

(75) Inventors: Balthasar Schillemeit, Bonn (DE); Thomas Klotten, Koln (DE)

(73) Assignee: VISTEON GLOBAL TECHNOLOGIES, INC., Van Buren Twp., MI (US)

(21) Appl. No.: 12/961,801

(22) Filed: Dec. 7, 2010

(30) Foreign Application Priority Data
Dec. 21, 2009 (DE) 102009055107.7

(51) Int. Cl. F16F 7/10

(52) U.S. Cl. 188/378

(57) ABSTRACT

The invention relates to an attachment arrangement for vibration decoupling for a refrigerant compressor in motor vehicles. The refrigerant compressor is provided with a mounting opening, wherein a decoupling member made of a vibration damping material is arranged. In the decoupling member a fastening member in form of a hollow-cylindrical fastening sleeve is provided, which is rigid in axial direction. A fastening member axially penetrates the fastening sleeve, by force-closure connecting the fastening sleeve to a fastening point at the motor vehicle over a counterpart. The decoupling member is provided at the mounting opening on the end side in axial direction radially protruding in each case with a flange for form-closed accommodation of the refrigerant compressor.

### CROSS-REFERENCE TO RELATED APPLICATION

This application claims priority to German Patent Application Ser. No. DE 10 2009 055 107.7 filed Dec. 21, 2009, the entire disclosure of which is hereby incorporated herein by reference.

### FIELD OF THE INVENTION

The invention relates to an attachment arrangement for vibration decoupling of a refrigerant compressor of an HVAC system in motor vehicles.

### BACKGROUND OF THE INVENTION

It is known in the prior art to attach electrical refrigerant compressors for automotive applications either to the internal combustion engine or to the motor vehicle body. The parts moving within the compressor generate vibrations, which in turn cause noise emission. The noise generating vibrations are, on the one hand, emitted as airborne sound and, on the other hand, transferred as structure-borne sound into coupled structures.

For a refrigerant compressor rigidly mounted to the internal combustion engine, the prior art prefers fixed fastening established as a threaded connection, in order to tune the natural frequency of the fastened compressor as high as possible.

Fastening the compressor of the HVAC system to the vehicle body requires expensive decoupling solutions, in order to tune the natural frequency of the rigidly fixed (e.g. bolted) compressor as low as possible, thereby minimizing the transfer of the structure-borne sound to the vehicle body.

In hybrid vehicles, it is preferred to attach the compressor of the HVAC system to the internal combustion engine, in order to make the smallest possible modifications compared with versions with traditional drive. The compressor is bolted to the casing of the internal combustion engine with several fastening bolts.

In hybrid vehicles, especially high demands on the reduction of the noise emitted by the compressor have to be satisfied because the HVAC system, and of all its constituents, the refrigerant compressor is the dominant noise source in the vehicle during operation without the internal combustion engine.

The output of electrically driven compressors is controlled over the rotational speed with the vibration and noise excitation increasing with rising rotational speed. As at higher rotational speeds, the electrically driven compressor fastened to the engine creates noise and vibrations that are more strongly heard and felt, the compressor is particularly at lower engine speeds perceived as a stronger source of annoyance than a traditional mechanically driven compressor, which is directly driven by the engine. Additionally, electrically driven compressors create vibrations with higher frequencies compared with mechanically driven compressors, the vibrations transferred to the engine casing via the attachment arrangement. The transferred vibrations are additionally amplified by the resonant frequencies of the rigid attachment between compressor and engine, then emitted by the compressor and the engine casing. In hybrid vehicles with a switched off engine, these noises predominate markedly.

The above-mentioned disadvantages of the occurrence of vibrations are partly eliminated by known vibration-decoupled fastening systems with rubber members. The rubber members, however, cannot be used for fastening the compressor to the engine due to the high temperatures. The service life of the rubber members is very much limited due to the temperature load, and the installation volume required for an efficient sound reduction is very large.

For example, EP 35 91 00 A1 discloses a device for mounting a compressor into a vehicle engine compartment that is connected to a supporting arm with an opening that is arranged at the casing of the compressor. A vibration-isolating member is provided between a bolt-like fastening device and the supporting arm. Within the opening of the supporting arm, a sleeve is located through which the fastening device passes. The vibration-isolating member is fastened to a flange section of the sleeve with an adhesive, the member consisting of a layered arrangement of two steel disks with a rubber disk arranged therebetween.

Also, in EP 35 30 91 A2, a system for the attachment of a compressor of an automotive HVAC system is disclosed that serves to reduce vibrations transferred from the engine over the fastening device to the compressor. The system is provided with a member with a through hole, in the ends of which sleeves are arranged. The sleeves consist of an inner cylinder that also has a through hole, and an outer cylinder. Between the inner cylinder and the outer cylinder, which are arranged coaxially to each other, an elastically deformable member, preferably made of rubber, is placed. The elastically deformable member established as damper is mounted by use of a bolt passing through the through holes.

It is characteristic of the systems of the prior art that with the traditional rigid mounting of the electric compressor of the HVAC system to the engine using, for example, a bolting connection, vibrations are transferred from the compressor to the structure of the engine due to the connection. This vibration transfer causes amplification of the compressor noise and has a negative effect on the vehicle's comfort.

When a traditional vibration decoupling is used with decoupling members made of rubber between the compressor and the engine, the following disadvantages arise: larger installation volume and space requirement of the compressor with the fastening device so that the system cannot be used, particularly, for larger engines; shorter life of the decoupling members due to aging of the traditional rubber materials, hence increased danger of failure during the vehicle life due to high temperatures in the engine compartment, the heavy weight of the compressor and the high vibration load during operation of the vehicle by the engine; and time consuming and costly production, assembly and maintenance processes as to the decoupling members, which are complex in design and manufacture.

### SUMMARY OF THE INVENTION

It is the object of the invention to decouple a compressor of an HVAC system from the vehicle as to vibrations such that the transfer of the vibrations relevant for the compressor noise to the vehicle is minimized and at the same time, the demands of compact installation volume, little space requirement, and long service life are fulfilled. Further, it is intended that the device for decoupling should require only minimum time and cost effort during manufacture, assembly, and maintenance.

According to the invention, the problem is solved by an attachment arrangement for vibration decoupling for a refrigerant compressor of an HVAC system in motor vehicles according to the features of claim 1.

According to the concept of the invention, the refrigerant compressor is provided with a mounting opening in that a decoupling member is arranged. The decoupling member is advantageously made of a vibration-damping material, and at its ends in axial direction adjacent to the border of the mounting opening of the compressor casing is provided with a radially protruding flange. The decoupling member serves for form-closed mounting of the refrigerant compressor. As shown, the mounting opening and the decoupling member are designed correspondingly cylindrical.

Inside the decoupling member, a stabilizing member in form of a hollow-cylindrical fastening sleeve, established rigid in axial direction, is located. According to the invention, the fastening sleeve is axially penetrated by a fastening member and via a counterpart by force-closure connected to a fastening point at the motor vehicle.

The hollow-cylindrical decoupling member, the hollow-cylindrical fastening sleeve, and the cylindrical fastening member located therein are coaxially integrated into each other, placed in the mounting opening of the compressor casing. The fit, or the pressure, respectively, of the decoupling member is only determined by the diameter ratios of the mounting opening, the decoupling member, and the fastening sleeve.

In an advantageous embodiment of the invention with circular-cylindrical members, the external radius of the decoupling member corresponds to the internal radius of the mounting opening, which is established as a through hole, so that the decoupling member is introducible substantially exactly fitting into the mounting opening of the compressor casing. The internal radius of the decoupling member corresponds to the external radius of the fastening sleeve.

The flange, which in assembled condition is adjacent the border of the mounting opening of the compressor casing, of the decoupling member serves to enlarge the radial support surface of the front side of the decoupling member to neighboring components of the attachment arrangement. The given pressing of the flange of the decoupling member in axial direction is defined by the length ratios of the mounting opening, the fastening sleeve, and the thicknesses of the flanges. The extension of the fastening sleeve in direction of its longitudinal axis is longer than the extension of the mounting opening of the compressor casing. During assembly and thus, fastening according to the invention of the compressor casing to the vehicle, the fastening sleeve establishes a stop for the fastening member so that a too big deformation of the decoupling member is avoided. Therefore, the decoupling member also in assembled condition always maintains its vibration damping properties, because it serves only for form-closed guide, but does not serve for force-closed fixation.

An advantageous embodiment of the invention is the multipart design of the decoupling member. In a two-part design, both parts of the decoupling member are established with a flange at an axial end of the cylindrical form. This embodiment is advantageous in that the parts of the decoupling member can be introduced into the mounting opening of the compressor casing from either side, thus making assembly easier.

In this embodiment, the decoupling member is preferably established in form of a hollow-cylindrical sleeve, i.e. as decoupling sleeve. The internal radius of the decoupling sleeve is substantially constant over its total length, equivalent to the external radius of the fastening sleeve so that the fastening sleeve is introducible substantially exactly fitting into the decoupling sleeve.

According to an alternative embodiment, the decoupling member is established as a coating on the stabilizing member, that is the fastening sleeve. The decoupling member is connected to the stabilizing member in a difficult to detach or permanent manner. The component designed one-part of stabilizing member and decoupling member makes the assembly of the attachment arrangement easier.

According to another embodiment of the invention, the decoupling member is made of an elastic plastic material such as PTFE (polytetrafluor-ethylene) or another high-performance plastic material, an elastomer, plastic, or similar vibration-damping materials. The hollow-cylindrical decoupling sleeve or the decoupling member established as a coating is established thin-walled and usable for temperatures up to 140° C.

The stabilizing member may be made of a high-strength material such as steel or ceramic. It serves to absorb the axially applied forces. The axial forces are transferred from the fastening point over the fastening sleeve to the counterpart of the fastening member so that the members are connected to each other over the front sides of the fastening sleeve. Static friction prevents the members from sliding relative to each other. The adjacent surfaces, and so the members of the attachment arrangement, move relative to each other when the tangentially acting force is bigger than the friction force that is caused by the axial force. Force-closure causes self-retention of the connection. The static friction between the active surfaces prevents the connected members from moving.

According to an advantageous further embodiment of the invention, the stabilizing member established as fastening sleeve is designed multipart. The fastening sleeve has three segments oriented next to each other in an axial direction along the longitudinal axis of the attachment arrangement. The central segment, arranged between both external segments, is designed as a hollow cylinder. During the assembly of the attachment arrangement, the external segments, each located at an end of the central segment, are positively connected to the central segment. This form-closed connection of the segments enables absorbing the axial forces that are applied over the fastening members, which axially penetrates the fastening sleeve, just as with a one-part fastening sleeve. The multipart design combined with the decoupling member facilitates manufacture and assembly of the attachment arrangement.

It is advantageous when in assembled condition an intermediate piece is arranged on either end face of the fastening sleeve. The intermediate piece, which typically is established in form of a spacer or washer, is on the one hand, adjacent to the end faces of the fastening sleeve and the flange of the decoupling member and on the other hand, either to the engine casing or the counterpart of the attachment arrangement.

According to another embodiment of the invention, the intermediate piece is connected to the decoupling member so that fewer component parts have to be assembled.

Another advantage of the invention develops if the decoupling member is established as coating on the fastening sleeve. Then, the decoupling member and the fastening sleeve are permanently connected to each other while the intermediate piece is also in a fixed connection to the decoupling member. In another embodiment of the attachment arrangement with multipart fastening sleeve and multipart decoupling member, the external subsegments of the fastening sleeve are joined, first, with a part of the decoupling member and second, with an intermediate piece as undetachably connected units. So the attachment arrangement has a little number of single components making the assembly of the attachment arrangement easier.

Here again, an intermediate piece and an external subsegment of the multipart fastening sleeve each form a unit established as one part, whereby the hollow-cylindrical subsegment of the fastening sleeve at either end face is provided with a radially protruding flange as an intermediate piece at the mounting opening in the axial direction.

An advantageous embodiment of the invention is that the point of attachment is provided at the engine of the motor vehicle. Thus, the attachment arrangement connects the compressor casing to the engine. The force-closed connection is ensured over the fastening sleeve, the form-closed connection over the decoupling member. The form-closed connection is realized through the fits of the decoupling member in radial and axial directions. The decoupling member holds the compressor casing in the axial direction of the cylindrical mounting opening, preventing the compressor casing from moving relative to the engine. Due to the flexibility of the material of which the decoupling member is made, the vibrations between engine and compressor are effectively decoupled. Form-closure is made by way of putting together and bolting the components and is detachable, which makes it very much easier to demount and maintain the connection between engine and compressor.

In another embodiment of the invention, the fastening point is established as a blind hole with an internal thread.

The invention can be realized at particularly reasonable costs, if a bolt is provided as the fastening member. The bolt is externally threaded at one end so that the fastening member is screwable to the internal thread of the blind hole, the fastening point at the engine. The counterpart for clamping the fastening sleeve to the engine of the vehicle is the bolt head at the free end of the fastening member.

According to an alternative embodiment, the fastening member is established as threaded rod with one end being screwable to the fastening point, that is the blind hole with the internal thread. At the free end, the threaded rod is provided with a nut as counterpart.

The solution according to the invention has various advantages. The stabilizing member as a large-surface holding member, that is as a long, cylindrical sleeve with large external surface, is fixed but detachably connected to the engine casing and absorbs the forces of the connection between compressor casing and engine. The attachment arrangement according to the concept of the invention holds the compressor by means of the large-surface decoupling member, the cylindrical design with flange-like projections at the end faces, predominantly in form-closure with maximum vibration decoupling. The decoupling member, according to the concept, absorbs only little holding forces, the material properties for damping vibrations are specifically maintained.

The main advantages can be summarized as follows: small installation volume and space requirement of the device for fastening the compressor to the engine so that the system is also usable with higher-power engines; longer life of the decoupling members compared with traditional rubber materials, hence lower danger of failure during the vehicle life due to, for example, a possible use at higher temperatures up to 140° C., therefore suitable as connection to an internal combustion engine; time- and cost-effective manufacture, assembly and maintenance processes due to detachable connections of the members of the attachment arrangement that are mountable as single parts and the simple design and manufacture of the decoupling and stabilizing members.

### BRIEF DESCRIPTION OF THE DRAWINGS

Other details, features and advantages of the invention will become apparent from the following description of exemplary embodiments with reference to the accompanying drawings. It is shown by:

FIG. 1: attachment arrangement with screwing members, vibration damping decoupling sleeves, and a fastening sleeve in sectional view;

FIG. 2: fastening sleeve with vibration damping decoupling sleeves arranged at the end faces;

FIG. 3: attachment arrangement in assembled condition in perspective view; and

FIG. 4: attachment arrangement with screwing members, vibration damping decoupling sleeves and a multipart fastening sleeve in sectional view.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

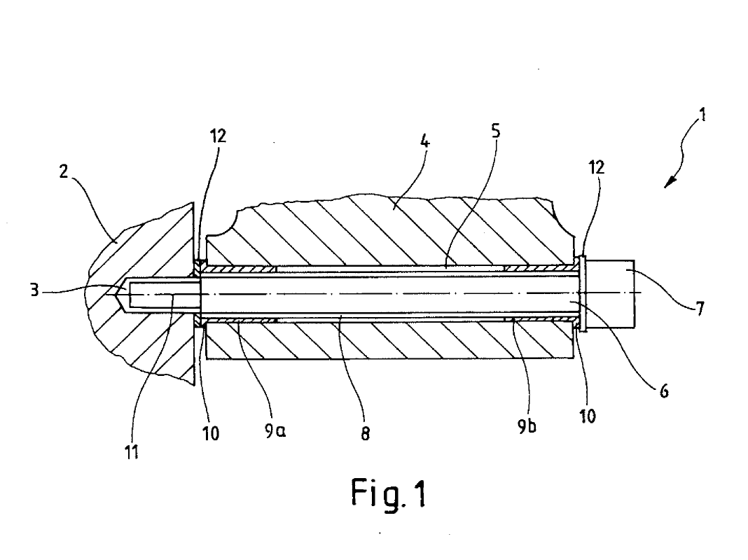

FIG. 1 shows a realization according to the invention of the attachment arrangement 1 in sectional view. This arrangement with screwing members, vibration damping decoupling sleeves 9a, 9b, and a one-part fastening sleeve 8 is an advantageous embodiment of the invention.

The compressor casing 4, which is provided with a through hole as mounting opening 5, is fastened to the point of attachment, the engine casing 2, by means of screwing members.

Inside the mounting opening 5 of the compressor casing 4, coaxially with the longitudinal axis 11 of the hole, a stabilizing member 8, established as the fastening sleeve, particularly as a tubular sleeve, and two vibration damping decoupling members 9a, 9b, also established as decoupling sleeves 9a, 9b each with a flange-shaped axial end, or a projection 10, respectively, at each end face are arranged. The decoupling sleeves 9a, 9b have a hollow-cylindrical shape with thin circumferential surfaces and are made of an elastic plastic material such as PTFE or EPDM (ethylene-propylene-diene-monomer), which is usable at temperatures of up to 140° C. The flanges 10 are positioned at an end of the sleeve 9a, 9b on the external circumferential surface of the hollow cylinder. The radius of the external circumferential surface of the sleeve 9a, 9b is extended sharply so that an edge is created between the external circumferential surface of the sleeve 9a, 9b and the flange 10. Hence, the flange 10 is limited by two radially arranged surfaces and a circumferential surface with the surface at the free end of the end face corresponding to the end face of the decoupling sleeve 9a, 9b. The radius of the internal circumferential surface of the decoupling sleeves 9a, 9b is substantially constant over the total length of the hollow cylinder.

The radius of the external circumferential surface of a hollow-cylindrical decoupling sleeve 9a, 9b corresponds to the radius of the through hole 5, or the internal radius of the mounting opening 5, respectively. Therefore the decoupling sleeves 9a, 9b are introduced as substantially exactly fitting on both sides into the through hole 5 of the compressor casing 4. The flange-shaped projections 10 of the decoupling sleeves 9a, 9b serve as stops. The decoupling sleeves 9a, 9b are recessed into the through hole 5 up to the flange 10 in each case. Thereby, on the one hand, the flanges 10 prevent a further movement of the decoupling sleeves 9a, 9b into the mounting opening 5. On the other hand, the flanges 10 enlarge the radial support surface, that is the area of the end face of the decoupling sleeve 9a, 9b against adjacent components of the attachment arrangement 1. Within the mounting opening 5, each decoupling sleeve 9a, 9b is advantageously arranged directly adjacent the compressor casing 4.

The stabilizing member 8, established as tubular sleeve, is in the radial direction positioned inside the decoupling sleeve 9a, 9b. The radius of the external circumferential surface corresponds to the radius of the internal circumferential surface of the hollow-cylindrical decoupling sleeves 9a, 9b so that the fastening sleeve 8 is introduced substantially exactly fitting into the decoupling sleeves 9a, 9b. On mounting, the decoupling sleeves 9a, 9b are slid on at the axial ends of the tubular-sleeve-shaped stabilizing member 8 such that the end faces of the decoupling sleeves 9a, 9b are flush with the ends of the fastening sleeve 8. So the extension of the fastening sleeve 8 in direction of the longitudinal axis 11 is longer than the extension of the mounting opening 5 of the compressor casing 4, namely by the length equal to double the width of the flange 10 of one of the decoupling sleeves 9a, 9b.

The stabilizing member 8, which is typically made of a high-strength material such as a metal, e. g. steel, or ceramic supports the attachment arrangement 1, which is established as suspension, against axially applied forces of the screw connection.

The screw connection serves to hold the compressor, or the compressor casing 4, respectively, at the engine casing 2. A fastening member 6 in form of a threaded rod, bolt, or screw is passed through the tubular stabilizing member 8, which is positioned within the through hole 5 of the compressor casing 4, and at one end screwed to the engine casing 2. Hereby the end is provided with an external thread that makes possible to make a screwed connection with an internal thread inside a blind hole 3 in the engine casing 2.

Due to the screwed connection, the compressor casing 4 and the engine casing 2 are pressed and clamped against each other. The decoupling sleeve 9a located within the through hole 5 of the compressor casing 4, especially the flange 10 of the decoupling sleeve 9a, is between the compressor casing 4 and the neighboring engine casing 2 so that the force of the screwed connection between the casings 2, 4 is directly transferred over the fastening sleeve 8. It is particularly advantageous in this embodiment of the invention that the force-closed connection is made over the fastening sleeve 8 and the form-closed connection over the decoupling member 9a, 9b which is established vibration damping so that the compressor casing 4 is indirectly connected to the engine casing 2 over the vibration damping decoupling sleeves 9a, 9b. This is the fundamental concept of the invention.

In mounted condition of decoupling member 9a, 9b and fastening sleeve 8 within the mounting opening 5, but unmounted condition of the fastening member 6 at the vehicle, the parallel faces of the decoupling sleeve 9a, 9b, that is the external sides of the flanges 10, are arranged slightly protruding at the end faces of the fastening sleeve 8. On mounting of the fastening member 6 and fastening of the compressor casing 4 to the engine casing 2, the flanges 10 are compressed at the end faces of the decoupling sleeve 9a, 9b and deformed such that the end faces of the flanges 10 of the decoupling sleeve 9a, 9b and the end faces of the fastening sleeve 8 are flush in one plane.

To FIG. 1, between the end faces of the decoupling sleeve 9a and fastening sleeve 8, arranged inside the through hole 5 of the compressor casing 4, and the engine casing 2, that is the neighboring component of the attachment arrangement 1, an additional intermediate piece 12 in form of a washer or a spacer is provided. An equal intermediate piece 12 is at the second end of the screw connection between the end faces of the decoupling sleeve 9b and the fastening sleeve 8, and the counterpart 7 of the fastening member 6. According to FIG. 1 the counterpart 7 is equivalent to a screw head, but can also be designed as nut depending on the design of the fastening member 6.

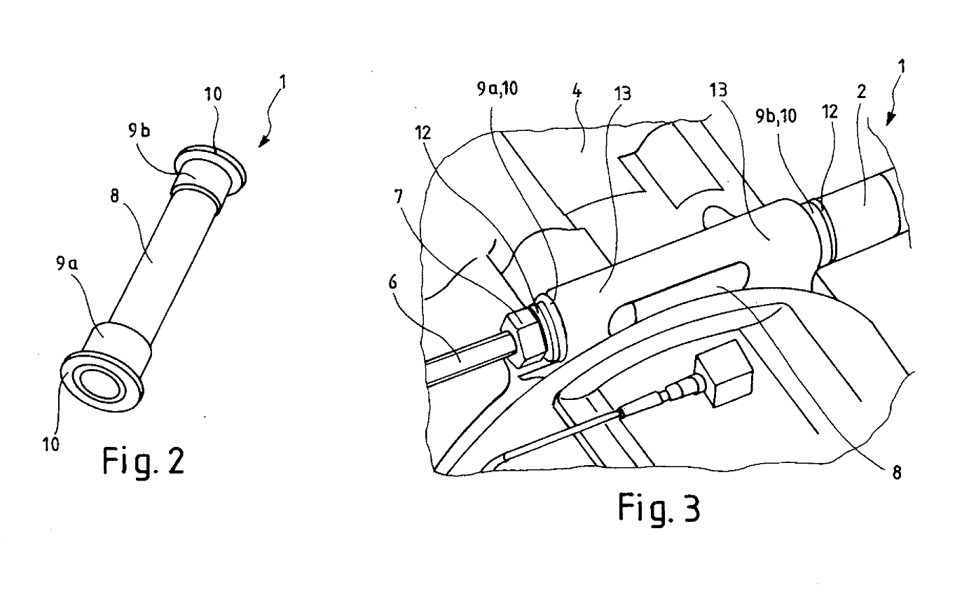

In FIG. 2 the fastening sleeve 8 with the end-side applied vibration damping decoupling sleeves 9a, 9b of the attachment arrangement 1 is perspectively shown that according to the invention ensures the vibration-related decoupling of the compressor casing 4 from the engine casing 2.

The fastening sleeve 8 and the decoupling sleeves 9a, 9b are joined coaxially to each other. Due to the equal external radii of the fastening sleeve 8 and the internal circumferential surface of the hollow-cylinder-shaped decoupling sleeves 9a, 9b, the decoupling sleeves 9a, 9b are substantially exactly fitting arranged around the stabilizing member 8. A press fit connects the members to each other.

The flange-shaped projections 10 of the axial ends of the decoupling sleeves 9a, 9b are oriented in opposite directions along the longitudinal axis 11 of the arrangement. The end face of the flange 10 and the top surface of the hollow-cylinder-shaped stabilizing member 8 are in the assembled condition not shown of the attachment arrangement 1 arranged flush, together forming a plane surface. The flanges 10 form the termination of the decoupling sleeves 9a, 9b and thus, the transition to components arranged adjacent.

FIG. 3 shows by analogy with FIG. 1 the attachment arrangement according to the invention in assembled condition in perspective view.

The through hole 5 of the compressor casing 4 is established of two fastening lugs 13 oriented in direction of the longitudinal axis 11 of the attachment arrangement 1. Adjacent to the radius of the inner surface of the lugs 13, the decoupling sleeves 9a, 9b are positioned, whereby the decoupling sleeves 9a, 9b are pushed into the lugs 13 up to their flange 10 each. Each flange 10 forms the termination of the decoupling sleeves 9a, 9b to the outside.

The compressor casing 4 is screwed to the engine casing 2 with help of a threaded rod as fastening member 6, the rod passed through the stabilizing member 8. Between the engine casing 2 as well as the nut established as counterpart 7 and the flange 10 of the decoupling sleeves 9a, 9b, a washer each is inserted as intermediate piece 12. Over the nut and the threaded rod, the compressor casing 4 and the engine casing 2 are clamped against each other within the attachment arrangement 1.

In this way, a design of an elastic part, the decoupling sleeves 9a, 9b established of thin-walled plastic material or elastomer sleeves, and a steel sleeve, the stabilizing member 8, is integrated into the fastening lugs 13 of the compressor casing 4 that as interacting unit are introduced into the through hole 5 of the compressor casing 4. The elastic part decouples the fastening lugs 13 of the compressor from the threaded rod, or a fastening screw, respectively, and functions to damp vibrations. The steel sleeve as the stabilizing member 8 transfers the screw force without loading the decoupling by the elastic decoupling sleeves 9a, 9b, and supports the attachment arrangement 1 in relation to axially applied forces of the screw connection. The attachment arrangement 1 is suitable to absorb heavy forces in all directions, inclusive of heavy shear forces, which particularly occur when components are attached to the sides of the engine.

For the decoupling sleeves 9a, 9b, a material is used that at very small external dimensions decouples high-frequency vibrations and nevertheless fulfills the requirements of dynamic strength when temperature loaded and of minimum space requirement at the same time. A functional range of up to 140° C. is a prerequisite for fastening electrically driven compressors or other components attached to the engine.

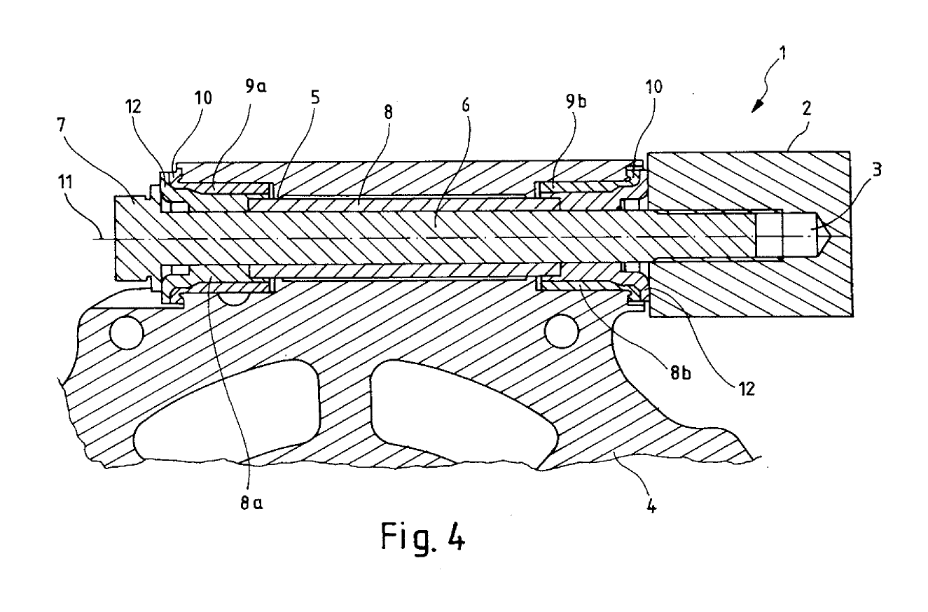

FIG. 4 shows the design of an attachment arrangement 1 with screw members, vibration damping decoupling sleeves 9a, 9b and a multipart fastening sleeve 8, 8a, 8b in sectional view. The fastening sleeve 8, 8a, 8b is in three parts with the segments arranged next to each other in direction of the longitudinal axis 11 of the attachment arrangement 1.

The central segment of the fastening sleeve 8 is arranged centrally between both external subsegments of the fastening sleeve 8a, 8b, and is established as a hollow cylinder. The hollow cylinder has a substantially constant radius of the internal surface and a substantially constant radius of the external surface as well. The external segments of the fastening sleeve 8a, 8b, each arranged at the ends of the central segment of the fastening sleeve 8, during assembly of the attachment arrangement 1 are pushed over the axial ends of the central segment. On the internal surface of the also hollow-cylindrical external subsegments, a shoulder is provided that is defined by surfaces with two different radii. The radius of the first internal surface corresponds to the radius of the external surface of the central segment of the fastening sleeve 8. The radius of the second surface that defines the shoulder of the external subsegments of the fastening sleeve 8a, 8b is smaller than the radius of the first surface and preferably corresponds to the radius of the internal surface of the central segment so that in assembled condition of the fastening sleeve 8, 8a, 8b the internal surface has a substantially constant radius over the total length. During assembling the fastening sleeve 8, 8a, 8b, the external subsegments with the bigger radii are slipped over the central segment. The final position of the segments 8, 8a, 8b is reached when the end faces of the central segment of the fastening sleeve 8 get in touch with the stops on the inside of the external subsegments of the fastening sleeve 8a, 8b. This connection of the segments enables to absorb the forces of the attachment arrangement 1 axially applied over the fastening member 6 that axially penetrates the fastening sleeve 8, 8a, 8b.

The external subsegments of the fastening sleeve 8a, 8b are, further, advantageously formed such that they fulfill the function of the intermediate pieces 12 between the flanges 10 of the decoupling members 9a, 9b and the fastening point 2 or counterpart 7 of the screwing members. An intermediate piece 12 and an external subsegment each of the multipart stabilizing member 8 are established as a subpiece, whereby the hollow-cylindrical segment of the stabilizing member 8a, 8b at the mounting opening 5 on the end side in axial direction radially protruding in each case is provided with a flange as intermediate piece 12.

The decoupling member 9a, 9b is established as a coating on the external subsegment of the stabilizing member 8a, 8b. Due to the one-part design of the external subsegment of the fastening sleeve 8a, 8b with integrated intermediate pieces 12 combined with the decoupling members 9a, 9b being directly applied to the external surfaces of the subsegments, the number of components of the attachment arrangement 1 are minimized and assembly of the attachment arrangement 1 is made easier.

The attachment arrangement of the invention minimizes noises emitted by the compressor to the outside of as well as inside the vehicle. The noise emission of the compressor arranged at the engine casing 2 of a motor vehicle is minimized by that the compressor is decoupled from the engine with regard to the vibrations.

From the foregoing description, one ordinarily skilled in the art can easily ascertain the essential characteristics of the invention, and without departing from the spirit and scope thereof, can make various changes and modifications to the invention to adapt it to various usages and conditions.

### Nomenclature

1 attachment arrangement
2 fastening point, engine casing
3 blind hole
4 refrigerant compressor, compressor casing
5 mounting opening, through hole
6 fastening member
7 counterpart
8, 8a, 8b stabilizing member, fastening sleeve
9, 9a, 9b decoupling member, decoupling sleeve
10 flange, projection
11 longitudinal axis
12 intermediate piece
13 fastening lug

What is claimed is:

1. An attachment arrangement for vibration decoupling for a refrigerant compressor in a motor vehicle comprising:
a refrigerant compressor having a mounting opening formed therein;
a pair of vibration damping decoupling members formed from a vibration dampening material, each of the decoupling members having a radially outwardly extending flange formed on an end thereof, the decoupling members disposed in opposite ends of the mounting opening with at least a portion of the flange disposed adjacent the mounting opening;
a hollow stabilizing member having opposing ends and a longitudinal axis, the stabilizing member extending between the decoupling members in the mounting opening, the opposing ends of the stabilizing member received in the decoupling members, wherein the stabilizing member is substantially rigid in an axial direction; and
a fastening member extending through the stabilizing member and received in a fastening point of the motor vehicle to secure the compressor thereto.

2. The attachment arrangement according to claim 1, wherein the opposing ends of the stabilizing member are formed separately from a central segment of the stabilizing member and are attached thereto to form the stabilizing member.

3. The attachment arrangement according to claim 1, wherein the opposing ends of the stabilizing member extend through each of the decoupling members and are substantially flush with an end face of the flange of each of the decoupling members in the axial direction.

4. The attachment arrangement according to claim 1, wherein each of the decoupling members is a hollow cylindrical sleeve.

5. The attachment arrangement according to claim 1, wherein each of the decoupling members is a coating formed on the opposing ends of the stabilizing member.

6. The attachment arrangement according to claim 1, wherein the stabilizing member is formed from a metal.

7. The attachment arrangement according to claim 1, wherein the stabilizing member is formed from a ceramic.

8. The attachment arrangement according to claim 1, wherein the stabilizing member is a hollow cylindrical fastening sleeve.

9. The attachment arrangement according to claim 1, further comprising an intermediate piece abutting an end face of the flange of each of the decoupling members.

10. The attachment arrangement according to claim 9, wherein the intermediate piece is one of a washer and a spacer.

11. The attachment arrangement according to claim 1, wherein the fastening member is a threaded rod.

12. The attachment arrangement according to claim 1, wherein the fastening member is a bolt.

13. The attachment arrangement according to claim 1, wherein the decoupling members are formed from polytetrafluorethylene.

14. The attachment arrangement according to claim 1, wherein the decoupling members are formed from ethylene-propylene-diene-monomer.
